(19) United States
(12) Patent Application Publication
(10) Pub. No.: US 2009/0091104 A1
(43) Pub. Date: Apr. 9, 2009

(54) AIRBAG MODULE MOUNTING STRUCTURE FOR PASSENGER SEAT OF CAR

(76) Inventor: Hyeongho CHOI, Gwangmyeong-si (KR)

Correspondence Address: MORGAN, LEWIS & BOCKIUS LLP (SF), One Market, Spear Street Tower, Suite 2800, San Francisco, CA, 94105, US

(21) Appl. No.: 11/955,633

(22) Filed: Dec. 13, 2007

(30) Foreign Application Priority Data
Oct. 8, 2007 (KR) 10-2007-0100981

(51) Int. Cl. B60R 21/20

(52) U.S. Cl. 280/728.3

(57) ABSTRACT

A first airbag module mounting structure includes an airbag housing, and at least one band to support the housing and be attached to an instrument panel. The band may include a bracket at each end, for attachment to the instrument panel. The housing may have a groove for the band to be seated therein. A second structure includes an airbag housing, a door member attached to an instrument panel, and at least one band to support the housing and be attached to the door member. The door member may have a locking hole, and the band may include a connecting pin at each end configured to be attached in the locking hole. The door member may have a slit for the band to be disposed therethrough. The band may be two bands connected by a buckle. The band may include a hook to be attached to the housing.

### CROSS-REFERENCE TO RELATED APPLICATIONS

The present application is based on, and claims priority from, Korean Application Serial Number 10-2007-0100981, filed on Oct. 8, 2007, the disclosure of which is hereby incorporated by reference herein in its entirety.

### FIELD OF THIS INVENTION

The present invention relates to a passenger side airbag module mounting structure.

### BACKGROUND OF THE INVENTION

A typical passenger side airbag module has brackets integrally provided on an airbag housing. The airbag module is mounted by fastening the brackets to an instrument panel and to a mounting bracket of a cowl cross member with bolts. The upper portion of the housing is open, and is covered with a crash pad that covers the surface of the instrument panel.

In a low-speed collision, when the air bag is not inflated, a passenger's head sometimes hits the crash pad. The instrument panel is not deformed by the shock because it is supported by the airbag module and the cowl cross member. As a result, since the shock is not sufficiently absorbed, the passenger can be seriously injured.

Further, since the bolts are inserted down from the outside the instrument panel, the crash pad needs to be detached to unscrew the bolts and remove the airbag module for maintenance.

The above information disclosed in this Background section is only for enhancement of understanding of the background of the invention and therefore it may contain information that does not form the prior art that is already known in this country to a person of ordinary skill in the art.

### SUMMARY OF THE INVENTION

A first exemplary airbag module mounting structure includes an airbag housing, and at least one band configured to support the housing and be attached to an instrument panel. The band may include a bracket at an end thereof, configured to be attached to the instrument panel from beneath the instrument panel. The housing may have a groove for the band to be seated therein.

A second exemplary airbag module mounting structure includes an airbag housing, a door member configured to be attached to an instrument panel, and at least one band configured to support the housing and be attached to the door member. The door member may have a locking hole on a wall thereof, and the band may include a connecting pin at an end thereof configured to be attached in the locking hole. The locking hole may have a horizontal section extending inward from a surface of the wall; and a vertical section, distanced inward from the surface of the wall and connected to the horizontal section. The door member may have a slit for the band to be disposed therethrough. The band may be two bands connected by a buckle. The band may include a hook to be attached to the housing.

### BRIEF DESCRIPTION OF THE DRAWINGS

For better understanding of the nature and objects of the present invention, reference should be made to the following detailed description with the accompanying drawings, in which:

FIG. 1 is a perspective view of a passenger side airbag module according to an embodiment of the invention;

FIG. 2A is a cross-sectional view illustrating a mounting structure of an airbag module according to an embodiment of the invention;

FIG. 2B is a partial cross-sectional view showing a housing of the airbag module according to an embodiment of the invention;

FIG. 3 illustrates an airbag module mounting structure according to another embodiment of the invention;

FIG. 4 is an enlarged perspective view of a band connecting portion of FIG. 3;

FIGS. 5 and 6 illustrate airbag module mounting structures according to other embodiments of the invention; and

FIG. 7 is a view similar to FIG. 2A, with an end of the band detached for maintenance and replacement.

### DETAILED DESCRIPTION OF THE PREFERRED EMBODIMENTS

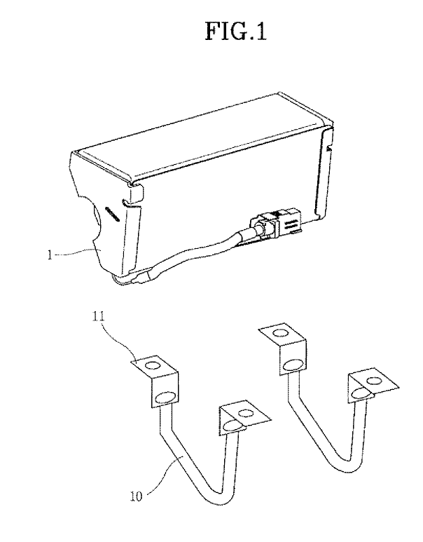

As shown in FIG. 1 a housing 1 of a passenger side airbag module according to an embodiment of the invention does not include integral brackets, but is instead mounted by brackets 11 on bands 10.

Bands 10 are made of a material with sufficient tensile strength to support weight of the airbag module and load applied thereto when the airbag is activated, but is not necessarily rigid. Exemplary materials are fabric, sheet metal, and rope.

A bracket 11 is connected to each end of each band 10. A slit may be provided at one end of each bracket 11, and the end of band 10 is inserted into and wound around the slit and then sewn. A bolt hole is provided at the other end of each bracket 11 to receive a boll B.

The airbag module is mounted by the following processes.

One of the two brackets of each band is first fixed by bolts B in front of an opening through an instrument panel 8 to allow an airbag to inflate.

The airbag module is located under the opening, bands 10 are wound up around the lower surface of the housing 1, and then the other bracket is fixed behind the opening by bolts B.

Bolts B are tightened upward by a tool that is inserted in an inner space in instrument panel 8, such as through a space for mounting a glove box 12 before the glove box 12 attached therein.

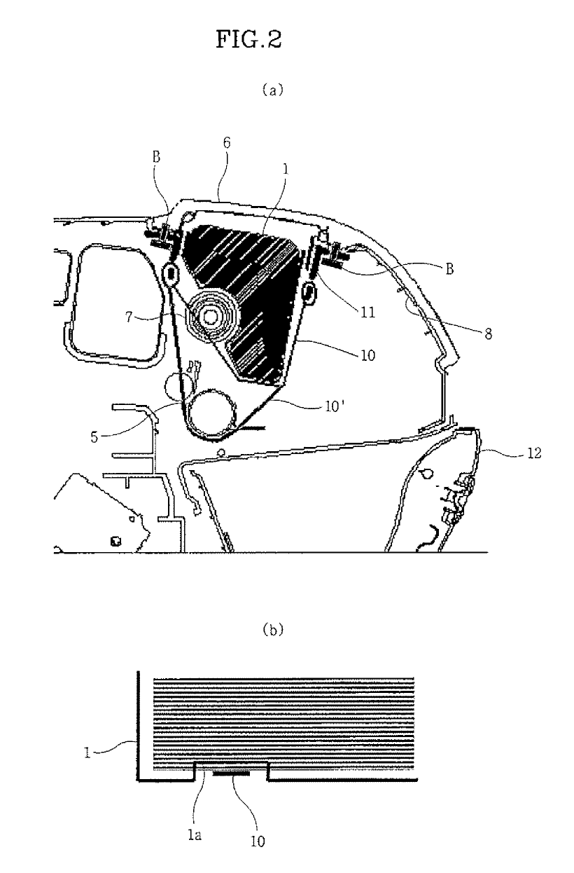

Alternatively, the band 10 is wound through the lower side of a cowl cross member 5. This portion of the band is indicated by reference numeral 10′ in FIG. 2A. In this structure, the upper front end of housing 1 is supported in front of the opening of instrument panel 8 and the lower rear end is supported by bands 10′. This configuration may be accomplished by attaching the front bolt B; winding the band 10, 10′ in the configuration shown; and then attaching the back bolt B.

As shown in FIG. 2B, grooves 1a are provided on the lower surface of housing 1 where the band 10 contacts the housing 1. Band 10 is seated in groove 1a, stably supporting the airbag module.

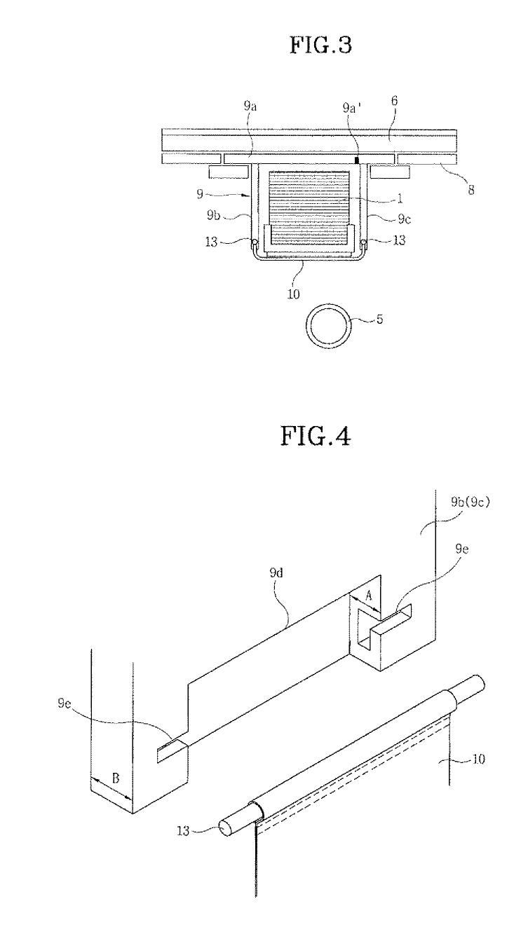

FIGS. 3 to 6 show embodiments of an airbag module further including a door member 9. While in the embodiment of FIG. 2, crash pad 6 acts as an air bag door, in the embodiment shown in FIG. 3, a separate door member 9 is provided, and the airbag module is disposed inside the door member.

Door member 9 is box-shaped with the lower side open and includes protrusions at the front and rear ends of an upper wall 9a. The protrusions are inserted and hooked in the opening of instrument panel 8, and when the airbag is activated, a tear line 9a′ on upper wall 9a is torn to allow the airbag cushion to inflate.

After housing 1 of the airbag module is inserted in door member 9, the lower ends of a front wall 9b and a rear wall 9c of door member 9 are connected by bands 10 to allow bands 10 to support the underside of housing 1.

Band 10 is connected to front and rear walls 9b and 9c of door member 9 by a connecting pin 13 provided at each end. As shown in FIG. 4, a recessed band seat 9d is provided on front and rear walls 9b and 9c of door member 9 (the depth A of band seat 9d<the thickness B of front and rear walls 9b and 9c) and a locking groove 9c is provided at each side of band seat 9d. The connecting pins 13 provided at the ends of band 10 are inserted in and locked to locking grooves 9e.

The end of band 10 is folded and sewn around the connecting pin 13.

Locking groove 9e is horizontal for some distance, and includes a vertical portion spaced back from the surface of the wall 9b or 9c. Therefore, when locking pins 13 are locked into the vertical portions of locking grooves 9e, both ends of band 10 are connected to the lower end of front and rear walls 9b and 9c of door member 9.

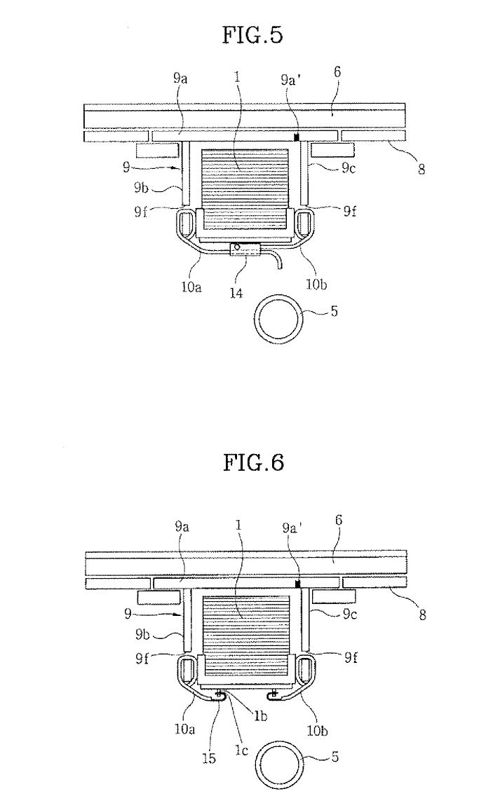

FIG. 5 shows another embodiment of an airbag module with a door member 9, in which a slit 9f having a sufficient width for band 10 to be inserted therein is provided at the lower portion of front and rear walls 9b and 9c of door member 9. The two ends of separate bands 10a and 10b are inserted in slits 9f and wound around the lower ends of front and rear walls 9b and 9c and then sewn to each of bands 10a and 10b.

A buckle 14 is provided at the end of one of bands 10a and 10b and the end of the other band is attached thereto in a manner that can be designed by a person of ordinary skill in the art based on the teachings herein.

FIG. 6 shows another embodiment of an airbag module with a door member 9, in which, as in the embodiment shown in FIG. 5, hands 10a and 10b are inserted in slits 9f formed at the lower portions of front and lower walls 9b and 9c of door member 9 and then sewn to the bands.

A U-shaped hook 15 is connected to an end of each band 10a and 10b, a locking protrusion 1b is provided on each hook 15, and a locking hole 1c is provided at a corresponding position on housing 1.

The operational effect of an airbag module for passenger seat according to an embodiment of the invention is now described.

According to an embodiment of the invention, the airbag module is suspended from instrument panel 8 or from walls 9b and 9c of door member 9 by bands 10, 10a, and 10b supporting the lower side of housing 1.

Thus, the reaction force against inflation of the airbag cushion is supported by bands 10, 10a, and 10b.

Therefore, when the head of a passenger seated at the passenger seat hits crash pad 6 in a low-speed car crash, during which the air bag does not inflate, crash pad 6 and instrument panel 8 are not supported by the airbag module, such that they can deform and absorb the shock. As a result, damage to the head of the passenger is reduced.

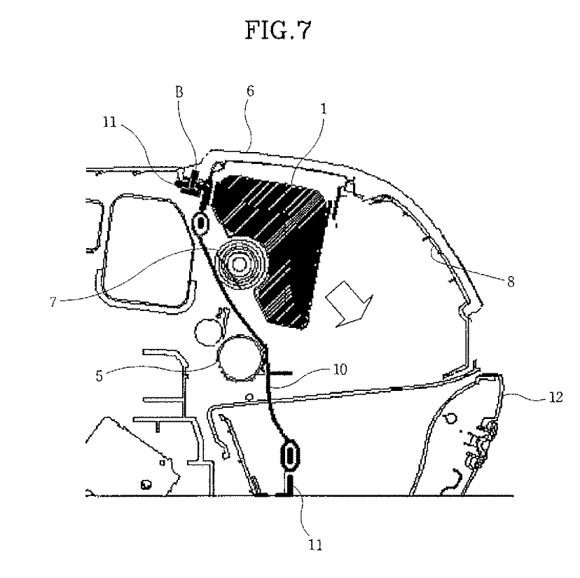

Also, as shown in FIG. 7, a tool can be inserted into the inner space formed by instrument panel 8 through a space for mounting glove box 12 to unscrew the bolts for maintenance or replacement of the airbag module.

The brackets and bands are then moved down and the airbag module is pulled out in the direction of the arrow in FIG. 7.

Further, to remove the module, in the embodiment shown in FIG. 3, connecting pins 13 are pulled out of locking holes 9e; in the embodiment shown in FIG. 5, buckle 14 is unbuckled; and in the embodiment shown in FIG. 6, hooks 15 are pulled out of locking holes 1c.

Therefore, it is not required to detach crash pad 6 to detach the airbag module, which facilitates maintenance and replacement of the airbag module.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An airbag module mounting structure, comprising:
an airbag housing; and
at least one band configured to support the housing and be attached to an instrument panel.

2. The structure as defined in claim 1, wherein the band comprises a bracket at an end thereof configured to be attached to the instrument panel from beneath the instrument panel.

3. The structure as defined in claim 1, wherein the housing comprises a groove configured for the band to be seated therein.

4. An airbag module mounting structure, comprising:
an airbag housing;
a door member configured to be attached to an instrument panel; and
at least one band configured to support the housing and be attached to the door member.

5. The structure as defined in claim 4, wherein a wall of the door member comprises a locking hole, and the band comprises a connecting pin at an end thereof configured to be attached in the locking hole.

6. The structure as defined in claim 5, wherein the locking hole comprises a substantially horizontal section extending inward from a surface of the wall, and a substantially vertical section distanced inward from the surface of the wall and connected to the substantially horizontal section.

7. The structure as defined in claim 4, wherein the door member comprises a slit configured for the band to be disposed therethrough.

8. The structure as defined in claim 7, wherein the band comprises two bands connected by a buckle.

9. The structure as defined in claim 7, wherein the band comprises a hook configured to be attached to the housing.
